(19) United States
(12) Patent Application Publication
(10) Pub. No.: US 2014/0340350 A1
(43) Pub. Date: Nov. 20, 2014

(54) SENSING CIRCUIT FOR TOUCH PANEL AND APPLIED TOUCH MODULE, ELECTRONIC APPARATUS AND CONTROL METHOD THEREOF

(71) Applicant: AU OPTRONICS CORP., Hsin-Chu (TW)

(72) Inventors: Chien-Jen CHEN, Hsin-Chu (TW); Tsang-Hong WANG, Hsin-Chu (TW); Yi-Ting CHIEN, Hsin-Chu (TW)

(73) Assignee: AU OPTRONICS CORP., Hsin-Chu (TW)

(21) Appl. No.: 14/062,280

(22) Filed: Oct. 24, 2013

(30) Foreign Application Priority Data
May 15, 2013 (TW) 102117239

(51) Int. Cl. G06F 3/044

(52) U.S. Cl. CPC G06F 3/044
USPC 345/174

(57) ABSTRACT

A control method for a touch panel is provided. The control method includes: generating the first sensing signal; simultaneously delivering the first sensing signal to the first sensing electrodes in every idle scan period and receiving a plurality of second sensing signals from the second sensing electrodes; and determining whether the touch panel is being touched or not according to the received second sensing signal and switching the touch panel from the idle mode to the normal mode if the touch panel is being touched. Sensing circuit and touch panel are also provided.

### TECHNICAL FIELD

The present invention relates to an operation way of a touch panel, and more particularly to an operation way of a touch panel capable of consuming less power.

### BACKGROUND

FIG. 1 is a schematic structure diagram of a conventional mutual capacitive touch panel. As shown, the conventional touch panel 100 includes a plurality of first electrodes (herein are exemplified by first electrodes 102, 104) and a plurality of second electrodes (herein are exemplified by second electrodes 112, 114); wherein the first electrodes 102, 104 are aligned in the X direction and the second electrodes 112, 114 are aligned in the Y direction. Specifically, a capacitor is formed at each one of the crossing points resulted by the crossing of the first electrodes and the second electrodes and accordingly a capacitor array is formed on the touch panel 100; wherein the capacitors are defined as sensing points (herein are exemplified by sensing points 122, 124). In addition, it is understood that the first electrode and the second electrode will not touch to each other if the respective sensing point is not being touched.

The conventional touch panel 100 is configured to sequentially scan the first electrodes and the second electrodes thereof. For example, the sensing input signals SI1, SI2 are sequentially inputted into the first electrodes 102, 104, respectively, and then the sensing output signals SO1, SIO2 are sequentially outputted from the second electrodes 112, 114, respectively. Thus, by reading the sensing output signals, the touch panel 100 can determine the positions of the sensing points being touched. In addition, it is understood that the second electrodes may be used for receiving the sensing input signals and the first electrodes may be used for outputting the sensing output signals in another prior art.

However, the first and second electrodes are kept being scanned sequentially and continuously even the touch panel 100 is in an idle state (that is, the touch panel 100 is not being touched for a while). As a result, the touch panel 100 still consumes electrical power even in the idle state.

### SUMMARY

Thus, the present disclosure provides a sensing circuit adapted to be used with a touch panel. The touch panel includes a plurality of sensing signal input terminals and a plurality of sensing signal output terminals. The sensing circuit includes a signal transceiver module and an idle-mode processing unit. The signal transceiver module, electrically coupled to the sensing signal input terminals and the sensing signal output terminals, is configured to output a first sensing signal. Wherein when the touch panel is operated in an idle mode, the signal transceiver module simultaneously outputs the first sensing signal to the sensing signal input terminals every idle scan period, receives a plurality corresponding second sensing signals from the sensing signal output terminals, respectively, and generates a third sensing signal according to the received second sensing signals. The idle-mode processing unit is electrically coupled to the signal transceiver module and configured to, when the touch panel is operated in the idle mode, receive the third sensing signal, determine whether the touch panel is being touched or not according to the received third sensing signal and thereby determining whether or not enable a wakeup signal for switching the touch panel from the idle mode to an normal mode.

The present disclosure further provides a touch module, which includes a sensing circuit and a touch panel including a plurality of sensing signal input terminals and a plurality of sensing signal output terminals. The sensing circuit includes a signal transceiver module and an idle-mode processing unit. The signal transceiver module, electrically coupled to the sensing signal input terminals and the sensing signal output terminals, is configured to output a first sensing signal. Wherein when the touch panel is operated in an idle mode, the signal transceiver module simultaneously outputs the first sensing signal to the sensing signal input terminals every idle scan period, receives a plurality corresponding second sensing signals from the sensing signal output terminals, respectively, and generates a third sensing signal according to the received second sensing signals. The idle-mode processing unit is electrically coupled to the signal transceiver module and configured to, when the touch panel is operated in the idle mode, receive the third sensing signal, determine whether the touch panel is being touched or not according to the received third sensing signal and thereby determining whether or not enable a wakeup signal for switching the touch panel from the idle mode to an normal mode. The touch panel further includes a plurality of first sensing electrodes and a plurality of second sensing electrodes. The first sensing electrodes are aligned in a first direction and electrically coupled to the sensing signals output terminals, respectively. The second sensing electrodes are aligned in a second direction and electrically coupled to the sensing signals input terminals, respectively. A capacitor is formed at each crossing point resulted by a crossing of the first sensing electrodes and the second sensing electrodes and thereby forming a capacitor array.

The present disclosure still further provides a control method for the aforementioned touch panel. The controlling method includes: generating the first sensing signal; simultaneously delivering the first sensing signal to the first sensing electrodes in every idle scan period and receiving a plurality of second sensing signals from the second sensing electrodes; and determining whether the touch panel is being touched or not according to the received second sensing signal and switching the touch panel from the idle mode to the normal mode if the touch panel is being touched.

In summary, by configuring the sensing circuit to simultaneously scan all/parts of the first electrodes of the touch panel operated in the idle mode, less power is consumed in the embodiments of the present invention. In addition, the touch panel is switched from the idle mode to the normal mode if the touch panel operated in the idle mode is being touched

### BRIEF DESCRIPTION OF THE DRAWINGS

The present disclosure will become more readily apparent to those ordinarily skilled in the art after reviewing the following detailed description and accompanying drawings, in which:

FIG. 1 is a schematic structure view of a conventional mutual capacitive touch panel;

FIG. 2 is a schematic block diagram of a touch module in accordance with an embodiment of the present disclosure;

FIG. 3 is a schematic block diagram of the signal transceiver module in FIG. 2 in accordance with an embodiment of the present disclosure;

FIG. 4A is a schematic circuit diagram of the analog processing unit in FIG. 3 in accordance with an embodiment of the present disclosure;

FIG. 4B is a schematic circuit diagram of the analog processing unit in FIG. 3 in accordance with another embodiment of the present disclosure;

FIG. 5 is a schematic block diagram of the idle-mode processing unit in FIG. 2 in accordance with an embodiment of the present disclosure;

FIG. 6 is a schematic block diagram of the normal-mode processing module in FIG. 2 in accordance with an embodiment of the present disclosure;

FIG. 7 is a schematic block diagram of an electronic apparatus in accordance with an embodiment of the present disclosure; and

FIG. 8 is a flowchart illustrating a control method for a touch panel in accordance with an embodiment of the present disclosure.

### DETAILED DESCRIPTION OF PREFERRED EMBODIMENTS

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

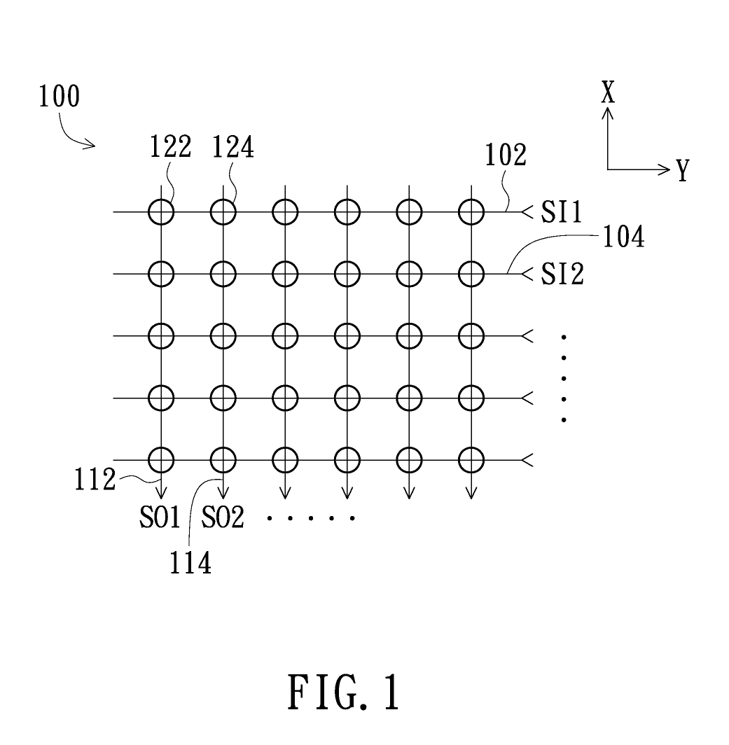

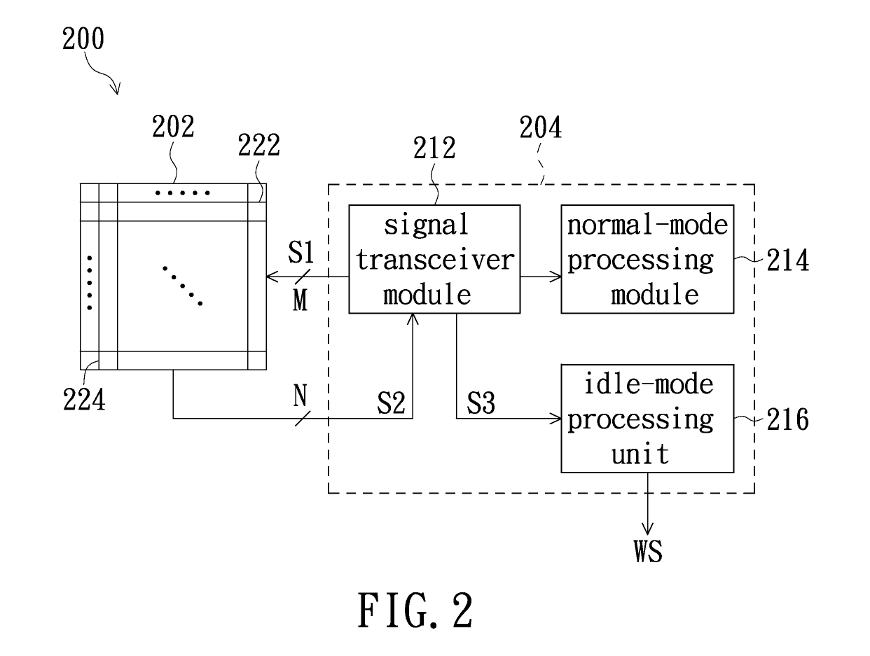

FIG. 2 is a schematic block diagram of a touch module in accordance with an embodiment of the present disclosure. As shown, the touch module 200 in this embodiment includes a touch panel 202 and a sensing circuit 204; wherein, the touch panel 202 may be realized by the touch panel 100 of FIG. 1 in one embodiment. The sensing circuit 204 includes a signal transceiver module 212, a normal-mode processing module 214 and an idle-mode processing unit 216. Specifically, the signal transceiver module 212 is electrically coupled to the touch panel 202, the normal-mode processing module 214 and the idle-mode processing unit 216.

The touch panel 202 includes M first electrodes 222 and N second electrodes 224 both electrically coupled to the signal transceiver module 212. When the touch panel 202 is operated in a normal mode, the sensing circuit 204 is configured to scan the M first electrodes 222 sequentially; that is, the signal transceiver module 212 is configured to output a sensing signal 51 to each one of the M first electrodes 222 in an one-by-one manner while the sensing circuit 204 is scanning the M first electrodes 222. Meanwhile when the signal transceiver module 212 is outputting the sensing signals S1 to one of the M first electrodes 222, the signal transceiver module 212 is further configured to receive a sensing signal S2 from each one of the N second electrode 224. Then, the signal transceiver module 212 is further configured to output a sensing result to the normal-mode processing module 214 according to the received sensing signals S2. In the present embodiment, the total time for the sensing circuit 204 to sequentially scan all the M first electrodes 222 once is defined as one normal scan period.

Alternatively, when the touch panel 202 is operated in an idle mode, the normal-mode processing module 214 is disabled and the idle-mode processing unit 216 is enabled. In the idle mode, the signal transceiver module 212 is configured to simultaneously output one sensing signal S1 to all the M first electrode 222, simultaneously receive one sensing signal S2 from the N second electrodes 224 and accordingly output the sensing result to the idle-mode processing unit 216 in one idle scan period. To simultaneously output one sensing signal S1 to all the M first electrodes 222 and then simultaneously receive one sensing signal S2 from the N second electrodes 224, in one embodiment the M first electrodes 222 are electrically coupled one another and the N second electrodes 224 are electrically coupled one another. Thus, the touch panel 202 with an M×N array is regarded as a touch panel with a 1×1 array while being operated in the idle mode due to the M first electrodes 222 functions as one first electrode 222 and the N second electrodes 224 functions as one second electrode 224. And accordingly, while the touch panel 202 is operated in the idle mode, it is understood that the total time for the sensing circuit 204 to scan the touch panel 202 once is equal to the time for scanning one first electrode 222 and one second electrode 224 only. Thus, the sensing circuit 204 can have a shorter scanning time when the touch panel 202 is operated in the idle mode.

In one embodiment, the time length of the idle scan period may be equal to that of the normal scan period. In another embodiment, the time length of the idle scan period may be smaller than that of the normal scan period. Accordingly, the time length of the idle scan period is equal to the time for k first electrodes 222 are being scanned when the touch panel 202 operated in the normal mode; wherein k is equal to or greater than 1 and smaller than M. For example, the idle scan period may be defined to as the time for the even/odd numbered first electrodes 222 to be scanned or the time for the random number of the first electrodes 222 to be scanned. In other words, in one embodiment, the signal transceiver module 212 only sends one or less than M sensing signals S1 to the touch panel 202 in the normal scan period when the touch pad 202 is operated in the idle mode, where M is greater than or equal to 2. Thus, power saving is achieved in the embodiments of the present disclosure.

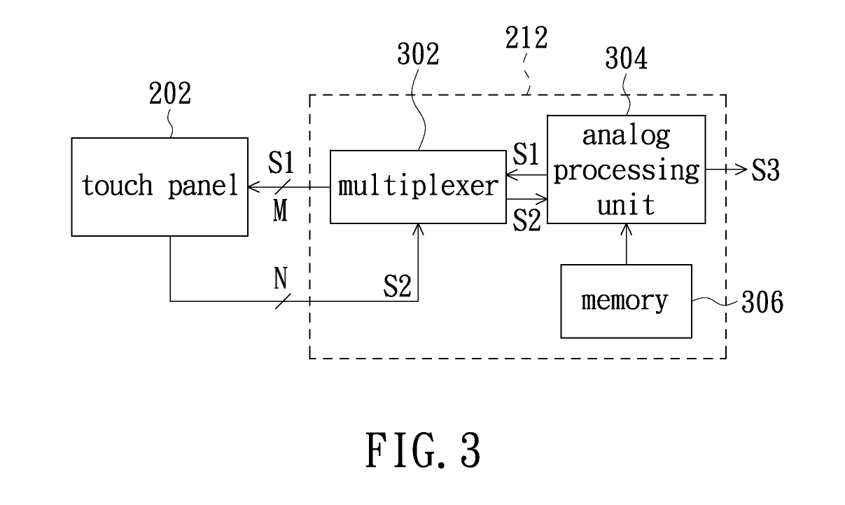

FIG. 3 is a schematic block diagram of the signal transceiver module 212 in FIG. 2 in accordance with an embodiment of the present disclosure. As shown, the signal transceiver module 212 in this embodiment includes a multiplexer 302, an analog processing unit 304 and a memory 306; wherein the analog processing unit 304 is electrically coupled to the multiplexer 302 and the memory 306. The multiplexer 302 includes a first input terminal, M first output terminals, N second input terminals and a second output terminal. Specifically, the first input terminal is electrically coupled to the analog processing unit 304; the M first output terminals are corresponding to the first input terminal and electrically coupled to the touch panel 202; the N second input terminals are electrically coupled to the touch panel 202; and the second output terminal is corresponding to the N second input terminals and electrically coupled the analog processing unit 304.

Please refer to FIGS. 2, 3 both. After receiving the sensing signal S1 through the first input terminal thereof, the multiplexer 302 is configured to simultaneously deliver the sensing signals S1 to the M first electrodes 222 thought the M first output terminals thereof, respectively, when the touch panel 202 is operated in the idle mode. In other words, all the M first electrodes 222 will simultaneously receive the sensing signal S1 from the multiplexer 302 when the multiplexer 302 receives the sensing signal S1 through the first input terminal thereof and the touch panel 202 is operated in the idle mode. Meanwhile, the multiplexer 302 receives the sensing signals S2 through the N second input terminals thereof from the N second electrodes 224 of the touch panel 202, respectively, when the touch panel 202 is operated in the idle mode and then deliver one sensing signal S2 to the analog processing unit 304 for further processing through the second output terminal thereof.

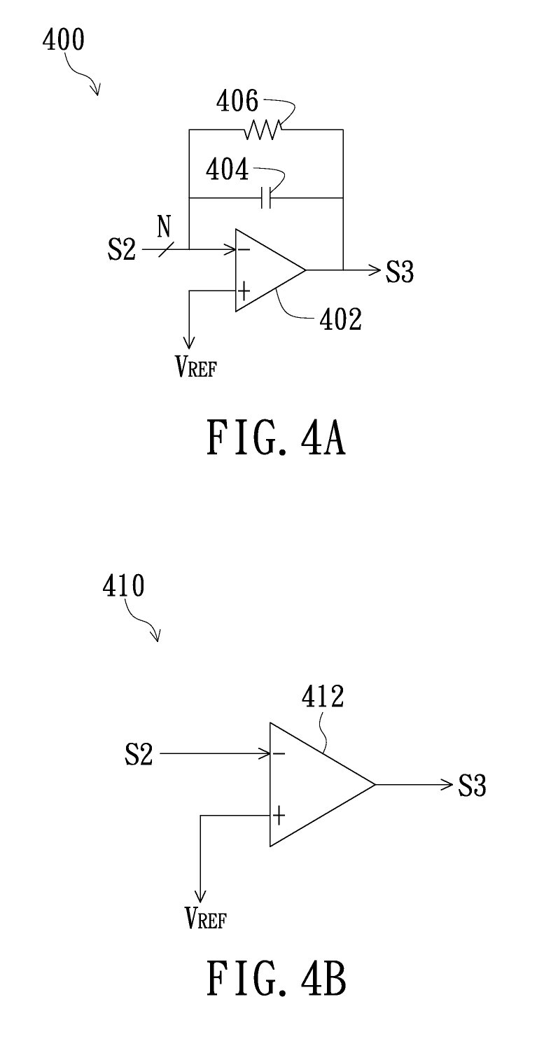

FIG. 4A is a schematic circuit diagram of the analog processing unit in FIG. 3 in accordance with an embodiment of the present disclosure; wherein the analog processing unit 400 in this embodiment has a circuit structure same as that of the analog processing unit 304 in FIG. 3. As shown, the analog processing unit 400 in this embodiment includes an amplifier 402, a feedback capacitor 404 and a feedback resistor 406. Specifically, the amplifier 402 is configured to have an negative input terminal thereof electrically coupled to the second output terminal of the multiplexer 302 in FIG. 3 for receiving the sensing signal S2 and a positive input terminal thereof electrically coupled to a reference voltage V_{REF}; wherein in one embodiment, the value of the reference voltage V_{REF} may be stored in the memory 306 in FIG. 3, and the memory 306 may be a read-only memory. In addition, the feedback capacitor 404 and the feedback resistor 406 both are configured to have the first terminals thereof electrically coupled to the negative input terminal of the amplifier 402 and the second terminals thereof electrically coupled to the output terminal of the amplifier 402, and thereby corporately forming an inverting amplifier circuit.

As illustrated in FIGS. 3, 4A, it is to be noted that when receiving the M sensing signals S2 from the M second electrodes 224, respectively, the multiplexer 302 delivers one sensing signal S2 to the negative input terminal of the amplifier 402. Then, the amplifier 402 is configured to output a sensing signal S3 according to the received sensing signal S2. Specifically, the sensing signal S3 is delivered to the idle-mode processing unit 216 for further processing as illustrated in FIG. 2 if the touch panel 202 is operated in the idle mode.

FIG. 4B is a schematic circuit diagram of the analog processing unit in FIG. 3 in accordance with another embodiment of the present disclosure; wherein the analog processing unit 410 in this embodiment has a circuit structure same as that of the analog processing unit 304 in FIG. 3. As shown, the analog processing unit 410 in this embodiment includes a comparator 412, which is configured to have a negative input terminal thereof electrically coupled to the second output terminal of the multiplexer 302 in FIG. 3 for receiving the sensing signal S2 and a positive input terminal thereof electrically coupled to a reference voltage V_{REF}. After comparing the sensing signal S2 with the reference voltage V_{REF}, the comparator 412 output the sensing signal S3 according to the comparison result.

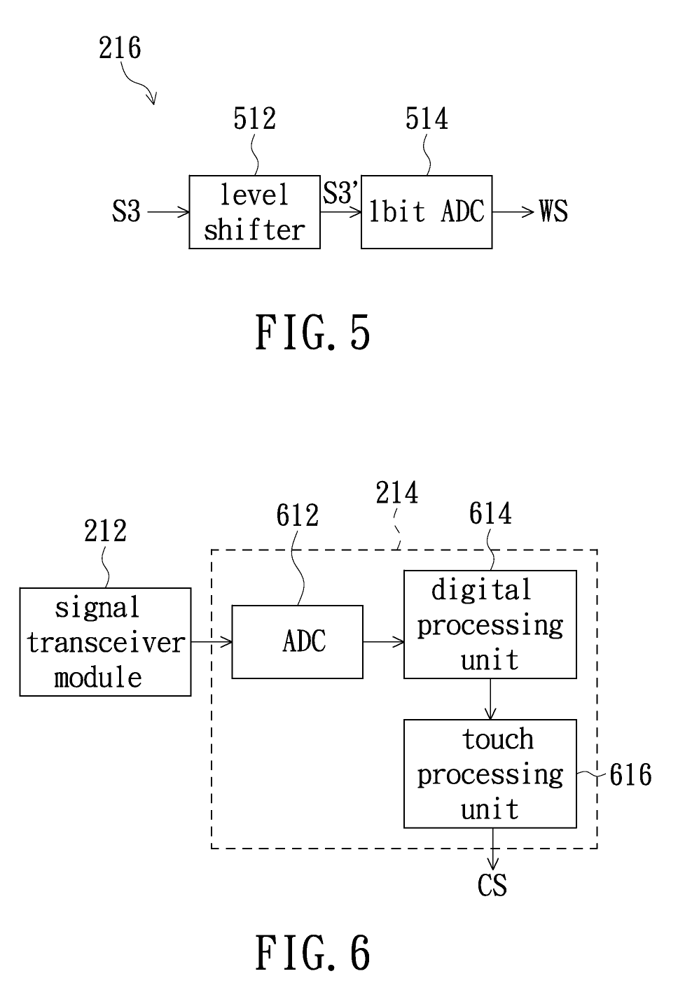

FIG. 5 is a schematic block diagram of the idle-mode processing unit 216 in FIG. 2 in accordance with an embodiment of the present disclosure. Please refer to FIGS. 2, 5 both. As shown, the idle-mode processing unit 216 in this embodiment includes a level shifter 512 and a one-bit analog-to-digital converter (1 bit ADC) 514. The level shifter 512 is electrically coupled to the signal transceiver module 212, and from which to receive the sensing signal S3; in addition, the level shifter 512 is further electrically coupled to the 1 bit ADC 514.

When the sensing signal S3 is inputted to the idle-mode processing unit 216, the level shifter 512 is configured to generate a sensing signal S3′ by shifting the potential level of the received sensing signal S3 and then deliver the sensing signal S3′ to the 1 bit ADC 514. If the touch panel 202 operated in the idle mode is not being touched, the potential level of the sensing signal S3′ is maintained within a predetermined potential level range and accordingly a logic-low (e.g., 0) is outputted from the 1 bit ADC 514. Alternatively, if the touch panel 202 operated in the idle mode is being touched, the potential level of the sensing signal S3′ will not locate within the predetermined potential level range and accordingly a logic-high (e.g., 1) is outputted from the 1 bit ADC 514. In this embodiment, a logic-high (e.g., 1) outputted from the 1 bit ADC 514 indicates that a wakeup signal WS is enabled; and accordingly, the touch panel 202 is switched from the idle mode to the normal mode and consequentially the normal-mode processing module 214 is enabled and the idle-mode processing unit 216 is disabled.

It is understood that the structure of the idle-mode processing unit 216 illustrated in FIG. 5 is used for an exemplary purpose only, and the concept of the present invention is not limited thereto.

FIG. 6 is a schematic block diagram of the normal-mode processing module 214 in FIG. 2 in accordance with an embodiment of the present disclosure. As shown, the normal-mode processing module 214 in this embodiment includes an analog-to-digital converter (ADC) 612, a digital processing unit 614 and a touch processing unit 616. The ADC 612 is electrically coupled between the signal transceiver unit 212 and the digital processing unit 614; and the digital processing unit 614 is further electrically coupled to the touch processing unit 616. In addition, it is understood that the structure of the normal-mode processing module 214 illustrated in FIG. 6 is used for an exemplary purpose only, and the concept of the present invention is not limited thereto.

Please refer to FIGS. 2, 6 both. As described above, when the touch panel 202 is operated in the normal mode, the analog-format sensing result is outputted from the signal transceiver unit 212 to the ADC 612. The ADC 612 then converts the analog sensing result into a digital format and then output the digital signal to the digital processing unit 614. The digital processing unit 614 then generates coordinate data according to the signal output from the ADC 612 and outputs the coordinate data to the touch processing unit 616. Then, the touch processing unit 616 outputs a corresponding control signal CS according to the received coordinate data.

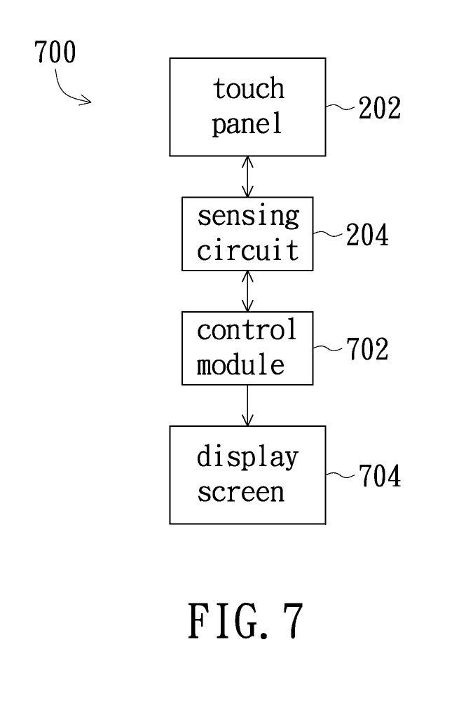

FIG. 7 is a schematic block diagram of an electronic apparatus in accordance with an embodiment of the present disclosure. Please refer to FIGS. 2, 7 both. As shown, the electronic apparatus 700 in this embodiment may be a laptop, smart phone, smart TV, etc., employing the aforementioned touch module 200 constituted with the touch panel 202 and the sensing circuit 204 as illustrated in FIG. 2. In addition, the electronic apparatus 700 further includes a control module 702 and a display panel 704. In one embodiment, the display panel 704 and the touch panel 202 each may be an individual component; in another embodiment, the touch panel 202 may be built in the display panel 704; and the present invention is not limited thereto.

In the present embodiment, the control module 702, electrically coupled between the sensing circuit 204 and the display panel 704, is configured to control the display panel 704 to display images thereon. In addition, the control module 702 is further configured to disable the idle-mode processing unit 216, enable the normal-mode processing module 214 and switch the touch panel 202 from the idle mode to the normal mode if an enabled wake-up signal WS is detected. In addition, when receiving the control signal CS from the normal-mode processing module 214, the control module 702 is further configured to control the electronic apparatus 700 to perform a corresponding operation according to the received control signal CS.

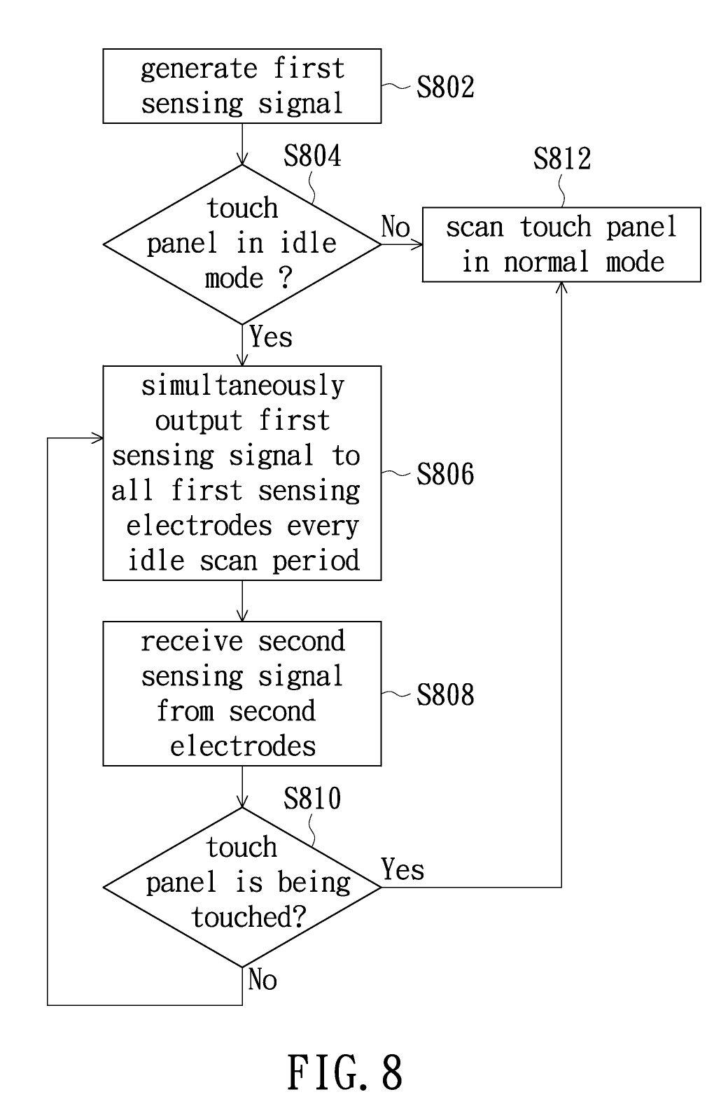

FIG. 8 is a flowchart illustrating a control method for a touch panel in accordance with an embodiment of the present disclosure; specifically, the control method in this embodiment is adapted to be used with the touch panel 200 in FIG. 1. As shown, the control method in this embodiment includes steps of: generating a first sensing signal (step S802); determining whether the touch panel is in an idle mode or not (step S804); scanning and controlling the touch panel in a normal mode (step S812) if the touch panel is not in the idle mode.

Alternatively, if the touch panel is in the idle mode, the control method in this embodiment further includes steps of: simultaneously delivering the first sensing signal to all of the first sensing electrodes of the touch panel in every idle scan period (step S806); receiving a plurality of second sensing signals from the second sensing electrodes of the touch panel (step S808); and determining whether the touch panel is being touched or not according to the second sensing signal (step S810).

As illustrated in FIG. 8, after step S810, the control method moves to step S812 and the idle mode is released if the touch panel in the idle mode is touched; alternatively, the control method moves to step S806 if the touch panel in the idle mode is not touched.

In summary, by configuring the sensing circuit to simultaneously scan all/parts of the first electrodes of the touch panel operated in the idle mode, less power is consumed in the embodiments of the present invention. In addition, the touch panel is switched from the idle mode to the normal mode if the touch panel operated in the idle mode is being touched.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A sensing circuit adapted to be used with a touch panel, the touch panel comprising a plurality of sensing signal input terminals and a plurality of sensing signal output terminals, the sensing circuit comprising:
a signal transceiver module, electrically coupled to the sensing signal input terminals and the sensing signal output terminals, configured to output a first sensing signal, wherein when the touch panel is operated in an idle mode, the signal transceiver module simultaneously outputs the first sensing signal to the sensing signal input terminals every idle scan period, receives a plurality corresponding second sensing signals from the sensing signal output terminals, respectively, and generates a third sensing signal according to the received second sensing signals; and
an idle-mode processing unit electrically coupled to the signal transceiver module and configured to, when the touch panel is operated in the idle mode, receive the third sensing signal, determine whether the touch panel is being touched or not according to the received third sensing signal and thereby determining whether or not enable a wakeup signal for switching the touch panel from the idle mode to an normal mode.

2. The sensing circuit according to claim 1, wherein the signal transceiver module comprises:
a multiplexer comprising a first input terminal, a plurality of first output terminals corresponding to the first input terminal, a plurality of second input terminals and a second output terminal corresponding to the second input terminals, wherein the first output terminals are electrically coupled to the sensing signal input terminals of the touch panel respectively, the second input terminals are electrically coupled to the sensing signal output terminals of the touch panel respectively, wherein the multiplexer is configured to deliver the first sensing signal to the sensing signal input terminals through the first output terminals thereof respectively after the first sensing signal is received through the first input terminal thereof, and output the second sensing signal through the second output terminal thereof after the second sensing signals are received from the sensing signal output terminals of the touch panel through the second input terminals thereof respectively; and
an analog processing unit comprising a first output terminal, a second output terminal and an input terminal, wherein the analog processing unit is configured to output the first sensing signal to the first input terminal of the multiplexer through the first output terminal thereof, receive the second sensing signal outputted from the multiplexer through the input terminal thereof, and output the third sensing signal through the second output terminal thereof according to the received second sensing signal.

3. The sensing circuit according to claim 2, wherein the analog processing unit comprises:
an amplifier comprising a positive input terminal, an negative input terminal and an output terminal, wherein the positive input terminal is electrically coupled to a reference voltage, the negative input terminal is electrically coupled to the input terminal of the analog processing unit, and the output terminal is electrically coupled to the second output terminal of the analog processing unit for outputting the third sensing signal;
a feedback capacitor comprising a first terminal electrically coupled to the negative input terminal of the amplifier and a second terminal electrically coupled to the output terminal of the amplifier; and
a feedback resistor electrically coupled to the feedback capacitor in parallel.

4. The sensing circuit according to claim 2, wherein the analog processing unit comprises:
a comparator comprising a positive input terminal, an negative input terminal and an output terminal, wherein the positive input terminal is electrically coupled to a reference voltage, the negative input terminal is electrically coupled to the input terminal of the analog processing unit, and the output terminal is electrically coupled to the second output terminal of the analog processing unit for outputting the third sensing signal.

5. The sensing circuit according to claim 4, wherein the idle-mode processing unit comprises:
a level shifter electrically coupled to the output terminal of the comparator and configured to shift the third sensing signal to a predetermined level; and
a first analog-to-digital converter electrically coupled to the level shifter and configured to determine whether or not to enable the wakeup signal according to an output of the level shifter.

6. The sensing circuit according to claim 1, further comprising a normal-mode processing module, wherein the normal-mode processing module comprises:
a second analog-to-digital converter electrically coupled to the signal transceiver module and configured to, when the touch panel is operated in the normal mode, receive the second sensing signals from the signal transceiver module and convert the received second sensing signals to have a digital format;
a digital processing unit electrically coupled to the second analog-to-digital converter and configured to receive the digital second sensing signals and generate a coordinate data according to the received digital second sensing signals in response to a touch is occurring on the touch panel in the normal mode; and
a touch processing unit electrically coupled to the digital processing unit and configured to receive the coordinate data from the digital processing unit and output a control signal according to the received coordinate data.

7. A touch module, comprising:
a sensing circuit; and
a touch panel comprising a plurality of sensing signal input terminals and a plurality of sensing signal output terminals,
wherein the sensing circuit comprises:
a signal transceiver module, electrically coupled to the sensing signal input terminals and the sensing signal output terminals, configured to output a first sensing signal, wherein when the touch panel is operated in an idle mode, the signal transceiver module simultaneously outputs the first sensing signal to the sensing signal input terminals every idle scan period, receives a plurality corresponding second sensing signals from the sensing signal output terminals, respectively, and generates a third sensing signal according to the received second sensing signals; and
an idle-mode processing unit electrically coupled to the signal transceiver module and configured to, when the touch panel is operated in the idle mode, receive the third sensing signal, determine whether the touch panel is being touched or not according to the received third sensing signal and thereby determining whether or not enable a wakeup signal for switching the touch panel from the idle mode to an normal mode,
wherein the touch panel further comprises:
a plurality of first sensing electrodes aligned in a first direction and electrically coupled to the sensing signals output terminals, respectively; and
a plurality of second sensing electrodes aligned in a second direction and electrically coupled to the sensing signals input terminals, respectively,
wherein a capacitor is formed at each crossing point resulted by a crossing of the first sensing electrodes and the second sensing electrodes and thereby forming a capacitor array.

8. A control method for a touch module, the touch module comprising a sensing circuit and a touch panel comprising a plurality of sensing signal input terminals and a plurality of sensing signal output terminals, the sensing circuit comprising a signal transceiver module and an idle-mode processing unit, the signal transceiver module, electrically coupled to the sensing signal input terminals and the sensing signal output terminals, being configured to output a first sensing signal, wherein when the touch panel is operated in an idle mode, the signal transceiver module simultaneously outputs the first sensing signal to the sensing signal input terminals every idle scan period, receives a plurality corresponding second sensing signals from the sensing signal output terminals, respectively, and generates a third sensing signal according to the received second sensing signals, the idle-mode processing unit being electrically coupled to the signal transceiver module and configured to, when the touch panel is operated in the idle mode, receive the third sensing signal, determine whether the touch panel is being touched or not according to the received third sensing signal and thereby determining whether or not enable a wakeup signal for switching the touch panel from the idle mode to an normal mode, the touch panel further comprising a plurality of first sensing electrodes and a plurality of second sensing electrodes, the first sensing electrodes being aligned in a first direction and electrically coupled to the sensing signals output terminals, respectively, the second sensing electrodes being aligned in a second direction and electrically coupled to the sensing signals input terminals, respectively, a capacitor being formed at each crossing point resulted by a crossing of the first sensing electrodes and the second sensing electrodes and thereby forming a capacitor array, the controlling method comprising:
generating the first sensing signal;
simultaneously delivering the first sensing signal to the first sensing electrodes in every idle scan period and receiving a plurality of second sensing signals from the second sensing electrodes; and
determining whether the touch panel is being touched or not according to the received second sensing signal and switching the touch panel from the idle mode to the normal mode if the touch panel is being touched.

9. The control method according to claim 8, wherein a time length of the idle scan period is equal to or smaller than that of a normal scan period, wherein the normal scan period is defined as a total time for the sensing circuit to sequentially scan all the first electrodes once while the touch panel is operated in the normal mode.

10. The control method according to claim 8, wherein at least one of the first sensing electrodes are scan randomly in the idle scan period.
